(19) United States
(12) Patent Application Publication
(10) Pub. No.: US 2021/0175733 A1
(43) Pub. Date: Jun. 10, 2021

(54) POWER MANAGEMENT SYSTEM AND METHOD

(71) Applicant: FLYTECH TECHNOLOGY CO., LTD, Taipei City (TW)

(72) Inventors: YUN-PING LIU, Taipei City (TW); SHUEI-JIN TSAI, Taipei City (TW)

(21) Appl. No.: 16/796,987

(22) Filed: Feb. 21, 2020

(30) Foreign Application Priority Data
Dec. 6, 2019 (TW) 108144746

(51) Int. Cl. H02J 7/00

(52) U.S. Cl. CPC H02J 7/00712; H02J 7/0047; H02J 7/0013

(57) ABSTRACT

A power management system and a power management method for a main system are provided. The power management system includes plural battery units and a charging management unit. A charging rule is executable by the charging management unit. The charging management unit is electrically connected with the plural battery units and the main system to dynamically detect electric quantities of the respective battery units and a system consumption power level of the main system. The charging management unit calculates a system surplus supply power level according to a system supply power level and the system consumption power level. The charging management unit dynamically adjusts charging capacities of the respective battery units according to at least one of the electric quantities, the system surplus supply power level and the charging rule.

### CROSS-REFERENCE TO RELATED APPLICATION

This application claims priority to Taiwanese Patent Application No. 108144746, filed Dec. 6, 2019, the contents of which are incorporated herein by reference.

### FIELD OF THE INVENTION

The present invention relates to a power management system and a power management method, and more particularly to a power management system with a charging management unit for dynamically detecting the electric quantities of plural battery units and a system consumption power level of a main system in order to dynamically adjust the priorities of charging the plural battery units and the charging capacities of the respective battery units.

### BACKGROUND OF THE INVENTION

Generally, a main system (e.g., a POS main system) is connected with plural peripheral devices. If the number of the peripheral devices is increased and the consumption power levels of the peripheral devices are high, the main system is usually equipped with a power management system. For example, the power management system of the main system comprises plural battery units and a high-specification adapter.

However, the conventional power management system still has some drawbacks. For example, since the cost of the high-specification adapter is high, the conventional power management system is not cost-effective. Since the peripheral device with high consumption power level (e.g., the printer) is usually not operated for a long time, the surplus electric power is not fully used and wasted. In other words, the installation cost is high.

Moreover, according to conventional charging method, plural battery units are charged by the adapter sequentially. That is, after a first battery unit is charged to be in the saturation state by the power management system, a next battery unit is charged. Moreover, different battery units are charged at the same charging capacity. For example, all battery units are charged at a fixed charging capacity (e.g., a current in the range between 0.2C and 0.5C). In such way, the performance of the adapter is impaired, and the total time period of charging the plural battery units is largely increased.

For overcoming the above drawbacks, there is a need of providing a novel, intelligent and high-efficiency power management system in order to effectively enhance the overall charging performance of plural battery units.

### SUMMARY OF THE INVENTION

The present invention provides a power management system and a power management method. Firstly, a charging management unit dynamically detects electric quantities of plural battery units and a system consumption power level of a main system. Then, the charging management unit calculates a system surplus supply power level according to the system supply power level and the system consumption power level. Consequently, the system surplus supply power level is effectively utilized, and the charging capacities to be provided to the plural battery units are dynamically adjusted.

In accordance with an aspect of the present invention, a power management system for a main system is provided. The power management system at least includes plural battery units and a charging management unit. The charging management unit is electrically connected with the plural battery units to dynamically detect electric quantities of the respective battery units and a system consumption power level of the main system. A charging rule is executable by the charging management unit. The charging management unit calculates a system surplus supply power level according to a system supply power level and the system consumption power level. The charging management unit dynamically adjusts charging capacities of the respective battery units according to at least one of the electric quantities, the system surplus supply power level and the charging rule.

In an embodiment, according to the charging rule, the charging management unit stops providing the charging capacities of the respective battery units if the system consumption power level is higher than the system supply power level and higher than a set value.

In an embodiment, the set value is 105% of the system supply power level.

In an embodiment, according to the charging rule, the charging management unit dynamically adjusts the charging capacities of the respective battery units if the system consumption power level is lower than the set value.

In an embodiment, the set value is 105% of the system supply power level, wherein according to the charging rule, the charging management unit dynamically decreases the charging capacity of at least one of the respective battery units if the system consumption power level is 101%˜104% of the system supply power level.

In an embodiment, according to the charging rule, the charging management unit dynamically increases the charging capacities of the respective battery units if the system consumption power level is lower than the system supply power level.

In an embodiment, the charging rule contains a charging mode, wherein the charging management unit dynamically adjusts the charging capacity of each battery unit when the charging management unit is in the charging mode.

In the charging mode, a single battery unit of the plural battery units is charged at a time. The charging management unit dynamically adjusts the charging capacity of each battery unit according to a charging sequence and a charging efficiency of each battery unit.

In the charging mode, a group of at least two battery units of the plural battery units is charged at a time. The charging management unit dynamically adjusts the charging capacities of the battery units in each group according to a charging sequence of each group of the plural battery units and a percentage of total electric quantities of the battery units in each group with respect to total electric quantities of all of the plural battery units.

In the charging mode, the plural battery units are simultaneously charged. The charging management unit dynamically adjusts the charging capacities of the battery units according to a percentage of the electric quantity of each battery unit with respect to total electric quantities of all of the plural battery units.

In an embodiment, the charging management unit stops providing, dynamically decreases, maintains or dynamically increases the charging capacities of the respective battery units, so that the charging management unit dynamically adjusts the charging capacities of the respective battery units.

In accordance with another aspect of the present invention, a power management method for a main system, a charging management unit and plural battery units is provided. The main system, the charging management unit and the plural battery units are electrically connected with each other. The power management method at least includes the following steps. Firstly, electric quantities of the respective battery units and a system consumption power level of the main system are dynamically detected. Then, the charging management unit calculates a system surplus supply power level according to a system supply power level and the system consumption power level. Then, the charging management unit dynamically adjusts charging capacities of the respective battery units according to at least one of the electric quantities, the system surplus supply power level and a charging rule.

In an embodiment, according to the charging rule, the charging management unit stops providing the charging capacities of the respective battery units if the system consumption power level is higher than the system supply power level and higher than a set value.

In an embodiment, the set value is 105% of the system supply power level.

In an embodiment, according to the charging rule, the charging management unit dynamically adjusts the charging capacities of the respective battery units if the system consumption power level is lower than the set value.

In an embodiment, the set value is 105% of the system supply power level, wherein according to the charging rule, the charging management unit dynamically decreases the charging capacity of at least one of the respective battery units if the system consumption power level is 101%˜104% of the system supply power level.

In an embodiment, according to the charging rule, the charging management unit dynamically increases the charging capacities of the respective battery units if the system consumption power level is lower than the system supply power level.

In an embodiment, the charging rule contains a charging mode, wherein the charging management unit dynamically adjusts the charging capacity of at least one of the plural battery units when the charging management unit is in the charging mode.

In the charging mode, a single battery unit of the plural battery units is charged at a time. The charging management unit dynamically adjusts the charging capacity of each battery unit according to a charging sequence and a charging efficiency of each battery unit.

In the charging mode, a group of at least two battery units of the plural battery units is charged at a time. The charging management unit dynamically adjusts the charging capacities of the battery units in each group according to a charging sequence of each group of the plural battery units and a percentage of total electric quantities of the battery units in each group with respect to total electric quantities of all of the plural battery units.

In the charging mode, the plural battery units are simultaneously charged. The charging management unit dynamically adjusts the charging capacities of the battery units according to a percentage of the electric quantity of each battery unit with respect to total electric quantities of all of the plural battery units.

In an embodiment, the charging management unit stops providing, dynamically decreases, maintains or dynamically increases the charging capacities of the respective battery units, so that the charging management unit dynamically adjusts the charging capacities of the respective battery units.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a power management system according to an embodiment of the present invention; and

FIGS. 2, 3 and 4 schematically illustrate a flowchart of a power management method for the power management system as shown in FIG. 1.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown.

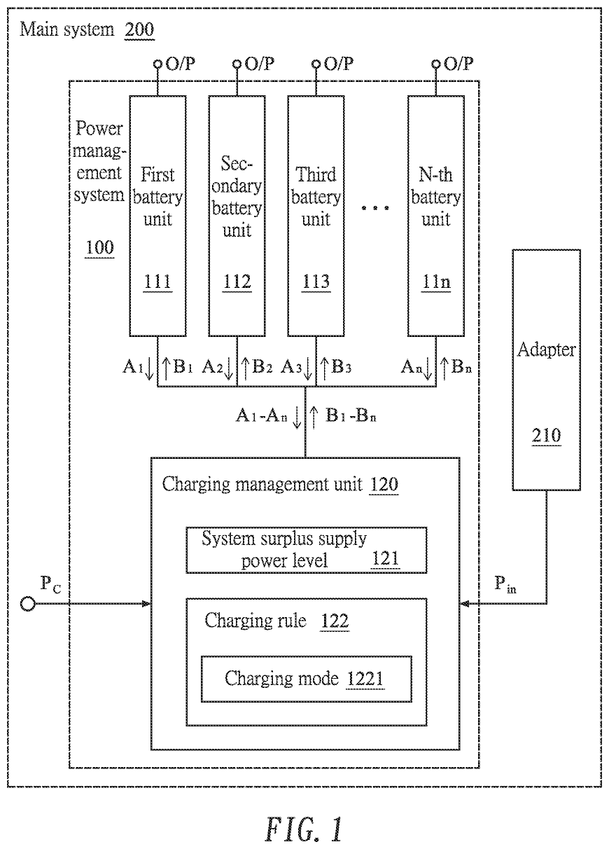

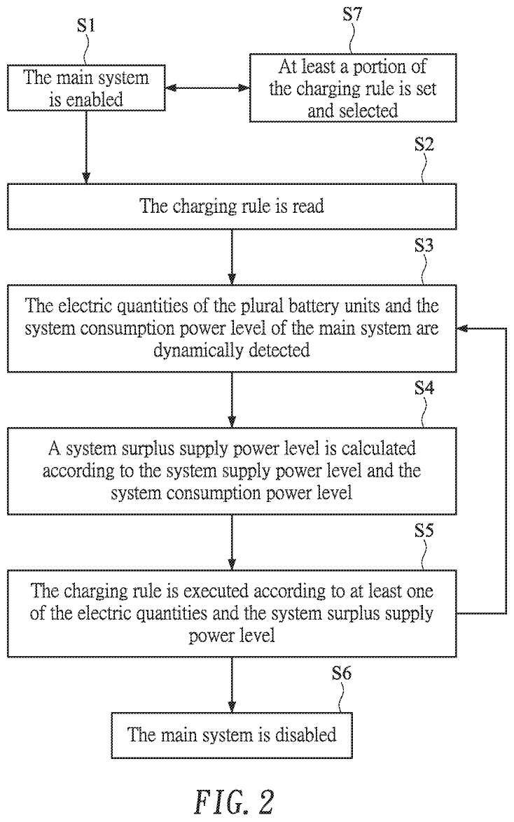

Please refer to FIGS. 1, 2, 3 and 4. FIG. 1 is a schematic functional block diagram illustrating a power management system according to an embodiment of the present invention. FIGS. 2, 3 and 4 schematically illustrate a flowchart of a power management method for the power management system as shown in FIG. 1.

As shown in FIG. 1, the power management system 100 is applied to a main system 200. The power management system 100 is electrically connected with an adapter 210 to receive a system supply power level Pin. The power management system 100 comprises plural battery units 111˜11n and a charging management unit 120. The charging management unit 120 is electrically connected with the plural battery units 111˜11n and the main system 200. The charging management unit 120 can dynamically detect the electric quantities A1˜An of the plural battery units 111˜11n and the system consumption power level Pc of the main system 200.

Preferably but not exclusively, the system supply power level Pin is 65 watts, 90 watts, 120 watts, 150 watts or 180 watts.

The system consumption power level Pc is the system consumption power level of the main system 200 in a specified operation time point. For example, the system consumption power level Pc contains the power consumption level of the at least one peripheral device (not shown) electrically connected with the main system 200 in a normal working state and the power consumption level of the electronic components in the main system 200.

According to the system supply power level Pin and the system consumption power level Pc, the charging management unit 120 calculates a system surplus supply power level 121. In accordance with a feature of the present invention, the plural battery units 111˜11n are charged in an intelligent manner according to the system surplus supply power level 121. Consequently, the overall performance of charging the plural battery units 111˜11n is enhanced and the main system 200 operation remains normal.

Particularly, a charging rule 122 is executable by the charging management unit 120. The charging rule 122 includes a charging mode 1221. Before the main system 200 is enabled, the charging mode 1221 can be selected or adjusted by the system user. Consequently, during the operation period of the main system 200, the charging management unit 120 can dynamically adjust the charging capacities B1˜Bn of the plural battery units 111˜11n according to at least one of the electric quantities A1˜An of the plural battery units 111˜11n, the system surplus supply power level 121 and the charging rule 122.

In accordance with the method of dynamically adjusting the charging capacities B1˜Bn of the plural battery units 111˜11n, the charging management unit 120 stops providing, dynamically decreases, maintains or dynamically increases the charging capacities B1˜Bn of the plural battery units 111˜11n (e.g., the charging capacities B1˜Bn are increased or decreased flexibly), and the charging management unit 120 dynamically adjusts the sequence of charging the plural battery units 111˜11n. Moreover, the charging management unit 120 can periodically (e.g., at a specified time interval such as 10 ms) acquires the consumed power conditions of the plural battery units 111˜11n (e.g., the electric quantities A1˜An) and the system consumption power level Pc of the main system 200 in a dynamic detecting manner or an active polling manner.

Preferably but not exclusively, the main system 200 is a point-of-sale (POS) system in the commercial sales place or a medical equipment.

FIGS. 2, 3 and 4 schematically illustrate a flowchart of a power management method for the power management system as shown in FIG. 1.

Please refer to FIGS. 1 and 2. The power management method for the power management system 100 applied to the main system 200 at least comprises the following steps.

In a step S1, the main system 200 is enabled. While the step S1 is performed, a step S7 is optionally performed. In the step S7, the system user may set and select at least a portion of the charging rule 122 before the main system 200 is enabled.

In a step S2, the charging rule 122 is read.

In a step S3, the electric quantities A1˜An of the plural battery units 111˜11n and the system consumption power level Pc of the main system 200 are dynamically detected.

In a step S4, the charging management unit 120 calculates a system surplus supply power level 121 according to the system supply power level Pin and the system consumption power level Pc.

In a step S5, the charging management unit 120 executes the charging rule 122 according to at least one of the electric quantities A1˜An and the system surplus supply power level 121.

In a step S6, the main system 200 is disabled.

As mentioned above, the charging rule 122 in the charging management unit 120 is read after the main system 200 is enabled. Then, the electric quantities A1˜An of the plural battery units 111˜11n and the system consumption power level Pc of the main system 200 that are electrically connected with the charging management unit 120 are acquired by the charging management unit 120 in a dynamic detecting manner or an active polling manner. The system consumption power level Pc at least contains the power consumption level of the at least one peripheral device (not shown) electrically connected with the main system 200 in a normal working state and the power consumption level of the electronic components in the main system 200. For example, the at least one peripheral device includes a printer, a thermal receipt printer, a monitor and any other appropriate peripheral device that is electrically connected with the main system 200.

Then, the charging management unit 120 calculates the system surplus supply power level 121 according to the system consumption power level Pc and the system supply power level Pin. Then, the charging management unit 120 executes the charging rule 122 according to at least one of the electric quantities A1˜An and the system surplus supply power level 121. Consequently, the charging capacities B1˜Bn of the plural battery units 111˜11n are dynamically adjusted according to the charging rule 122.

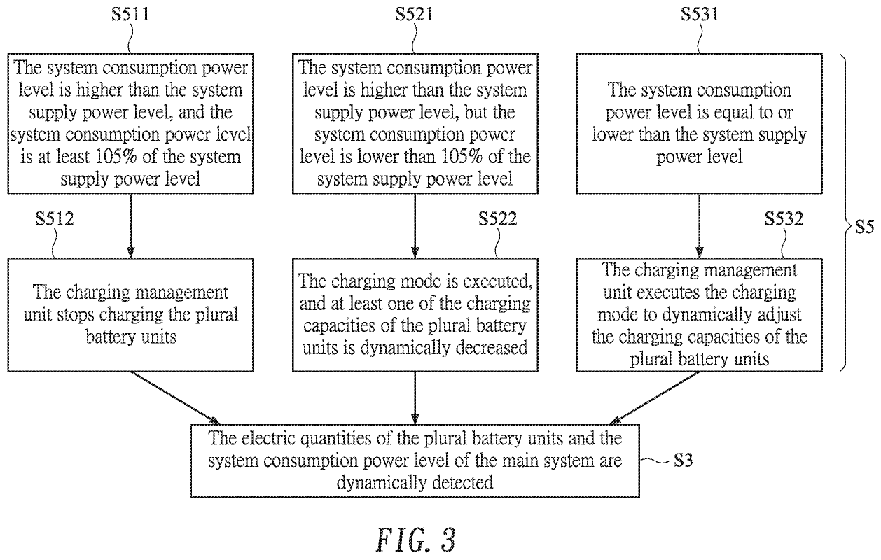

The examples of the step S5 of executing the charging rule 122 may be illustrated with reference to FIG. 3. FIG. 3 is the flowchart illustrating the steps of executing the charging rule 122.

As shown in FIG. 3, the step S5 of executing the charging rule 122 includes the following situations.

In a first situation, the system consumption power level Pc is higher than the system supply power level Pin, and the system consumption power level Pc is at least 105% of the system supply power level Pin (Step S511). Under this circumstance, the charging management unit 120 stops charging the plural battery units 111˜11n (Step S512).

In a second situation, the system consumption power level Pc is higher than the system supply power level Pin, but the system consumption power level Pc is lower than 105% of the system supply power level Pin (Step S521). Under this circumstance, the charging mode 1221 is executed, and at least one of the charging capacities B1˜Bn of the plural battery units 111˜11n is dynamically decreased (Step S522).

In a third situation, the system consumption power level Pc is equal to or lower than the system supply power level Pin (Step S531). Under this circumstance, the charging management unit 120 executes the charging mode 1221 according to at least one of the electric quantities A1˜An and the system surplus supply power level 121 in order to dynamically adjust (e.g., maintain, increase or decrease) the charging capacities B1˜Bn of the plural battery units 111˜11n (Step S532). For example, if the system consumption power level Pc is equal to or lower than the system supply power level Pin and the system consumption power level Pc is equal to or higher than 95% (or 93% or 97%) of the system supply power level Pin, the current charging mode is maintained. Whereas, if the system consumption power level Pc is lower than 95% of the system supply power level Pin, the charging mode 1221 is executed and the charging capacities B1˜Bn of the plural battery units 111˜11n are increased.

Please refer to FIGS. 2 and 3. After the step S5, the step S3 is repeatedly done. In a step S3, the charging management unit 120 dynamically detects the electric quantities A1˜An of the plural battery units 111˜11n and the system consumption power level Pc of the main system 200. Since the charging management unit 120 continuously detects the electric quantities A1˜An in the step S3 and the charging management unit 120 continuously executes the charging rule 122 in the charging management unit 120 in the step S5, the charging capacities B1˜Bn of the plural battery units 111˜11n are dynamically adjusted.

As mentioned above, if the system consumption power level Pc is higher than the system supply power level Pin of the adapter 210 and the system consumption power level Pc is equal to or higher than 105% (or 103%, 107%, 110% or 115%) of the system supply power level Pin, the charging management unit 120 stops charging the plural battery units 111˜11n. That is, the charging management unit 120 stops providing the charging capacities B1˜Bn to the plural battery units 111˜11n.

Alternatively, if the system consumption power level Pc is higher than the system supply power level Pin of the adapter 210 but the system consumption power level Pc is lower than 105% of the system supply power level Pin (e.g., 101%˜104% or 101%˜103% of the system supply power level Pin), the charging management unit 120 immediately decreases at least one of the charging capacities B1˜Bn of the plural battery units 111˜11n according to the electric quantities A1˜An of the plural battery units 111˜11n.

For example, if the system consumption power level Pc is 101%˜104% of the system supply power level Pin, the charging management unit 120 immediately decreases the charging currents of the plural battery units 111˜11n. For example, the charging current is decreased from 1000 mAh to 800 mA.

Alternatively, if the system consumption power level Pc is lower than the system supply power level Pin, the charging management unit 120 intelligently charges the plural battery units 111˜11n according to the system surplus supply power level 121. That is, the charging management unit 120 dynamically adjusts (e.g., maintains, increases or decreases) the charging capacities B1˜Bn of the plural battery units 111˜11n according to the electric quantities A1˜An of the plural battery units 111˜11n.

For example, if some of the electric quantities A1˜An are lower than 50%, the charging management unit 120 dynamically increases the charging capacities of the corresponding battery units. For example, the charging current is increased from 10 mAh to 20 mA. If some of the electric quantities A1˜An are in the range between 50% and 80%, the charging management unit 120 maintains the charging capacities of the corresponding battery units. If some of the electric quantities A1˜An are higher than 80%, the charging management unit 120 dynamically decreases the charging capacities of the corresponding battery units. For example, the charging current is decreased from 10 mAh to 5 mA. Since the charging management unit 120 dynamically adjusts the charging capacities B1˜Bn of the plural battery units 111˜11n according to the system surplus supply power level 121, the battery charging quality and the power management quality are effectively enhanced.

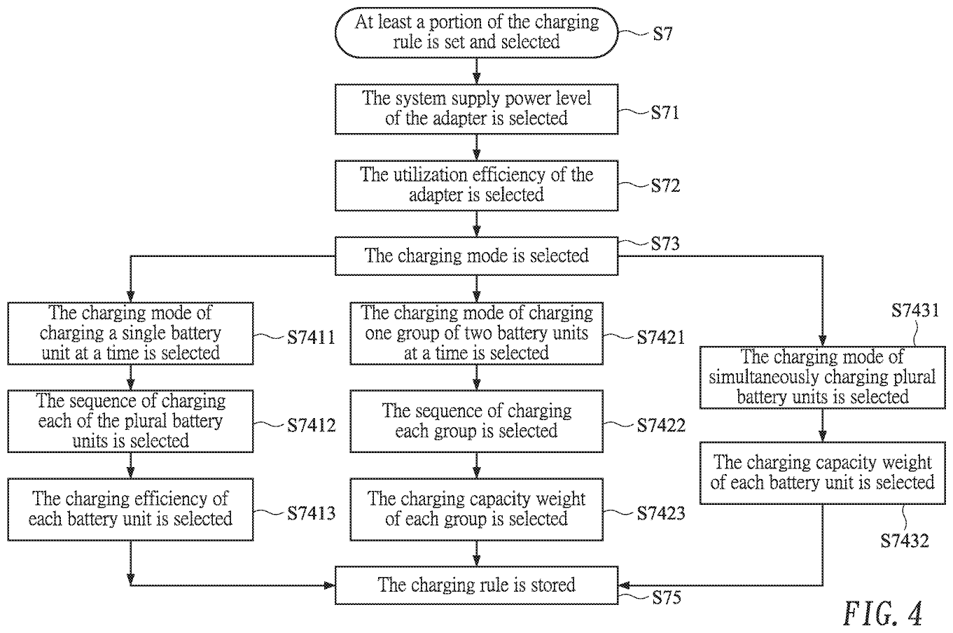

In the step S7, the system user may set and select at least a portion of the charging rule 122 before the main system 200 is enabled. As shown in FIG. 4, the step S7 of setting and selecting at least a portion of the charging rule 122 includes the following situations

As shown in FIG. 4, the step S7 comprises the following steps.

In a step S71, the system supply power level Pin of the adapter 210 is selected. For example, the system supply power level Pin is 65 watts, 90 watts, 120 watts, 150 watts or 180 watts according to the system user's selection and setting.

In a step S72, the utilization efficiency of the adapter 210 is selected.

In a step S73, the charging mode 1221 is selected.

Particularly, in the step S73, the system user selects one of plural charging modes 1221 in different situations.

In a first situation, the charging mode 1221 of charging a single battery unit at a time is selected (Step S7411). Then, the sequence of charging each of the plural battery units is selected (Step S7412), and the charging efficiency of each battery unit is selected (Step S7413).

In a second situation, the charging mode 1221 of charging one group of two battery units at a time is selected (Step S7421). Then, the sequence of charging each group of two battery units of the plural battery units is selected (Step S7422), and the charging capacity weight of each group of two battery units is selected (Step S7423).

In a third situation, the charging mode 1221 of simultaneously charging plural battery units is selected (Step S7431). Then, the charging capacity weight of each battery unit is selected (Step S7432).

After the charging mode 1221 (i.e., a portion of the charging rule 122) is selected and set by the system user, the charging rule 122 is stored into the charging management unit 120 (Step S75). Consequently, the charging rule 122 can be executed and used by the charging management unit 120.

As mentioned above, the system user may set and select at least a portion of the charging rule 122. In an embodiment, the charging mode 1221 of charging a single battery unit at a time is selected. In another embodiment, the charging mode 1221 of charging one group of at least two battery units (e.g., three battery units or four battery units) at a time is selected. That is, the at least two battery units in the same group are simultaneously charged. Alternatively, the charging mode 1221 of simultaneously charging plural battery units is selected.

In the Step S7412, the sequence of charging each of the plural battery units is selected. In the step S7422, the sequence of charging each group of two battery units of the plural battery units is selected. That is, the priorities of charging the plural battery units 111˜11n (i.e., the battery charging priorities) are determined according to the weight of each battery unit or each group of battery units or the electric quantities of the plural battery units.

Moreover, according to the charging mode, the subsequent charging condition is selected and adjusted. For example, when the single battery unit is charged in the step S7413, the charging capacity may be adjusted according to the electric quantity of the single battery unit. For example, the charging capacity is dynamically increased to implement a fast charging process, the charging capacity is maintained to implement a normal charging process, or the charging capacity is dynamically decreased to implement a slow charging process.

When the fast charging process is implemented, the original charging capacity is increased by 100%, 80% or 50%. When the normal charging process is implemented, the charging capacity is maintained. When the slow charging process is implemented, the original charging capacity is decreased by 80%, 50% or 30%.

In the step S7423 and the step S7432, the charging capacity weight of each battery unit is selected and calculated according to the type of the battery units. For example, the charging capacity weight is determined according to the percentage or the fraction of the total electric quantities of the battery units in a specified type with respect to the total electric quantities of all of the plural battery units. Consequently, the charging management unit dynamically provides the corresponding charging capacity to the single battery unit or each group of battery units according to the corresponding charging capacity weight. For example, the charging capacities are provided to each group of battery units or the plural battery units according to the percentage or the fraction of the total electric quantities of the battery units in each group with respect to the total electric quantities of all of the plural battery units or the percentage or the fraction of the electric quantity of each single battery unit with respect to the total electric quantities of all of the plural battery units.

Afterwards, the charging rule 122 is stored. Consequently, the charging rule 122 can be read and used by the charging management unit 120.

From the above descriptions, the present invention provides the power management system and the power management method. Firstly, the electric quantities of the plural battery units and the system consumption power level of the main system are dynamically detected. Secondly, the system surplus supply power level is calculated according to the system supply power level and the system consumption power level. Then, the charging capacities to be provided to the plural battery units are dynamically adjusted according to the system surplus supply power level and the electric quantities of the respective battery units. Consequently, the battery charging quality and the power management quality are effectively enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A power management system for a main system, the power management system at least comprising:
plural battery units; and
a charging management unit electrically connected with the plural battery units to dynamically detect electric quantities of the respective battery units and a system consumption power level of the main system,
wherein a charging rule is executable by the charging management unit, wherein the charging management unit calculates a system surplus supply power level according to a system supply power level and the system consumption power level, and the charging management unit dynamically adjusts charging capacities of the respective battery units according to at least one of the electric quantities, the system surplus supply power level and the charging rule.

2. The power management system according to claim 1, wherein according to the charging rule, the charging management unit stops providing the charging capacities of the respective battery units if the system consumption power level is higher than the system supply power level and higher than a set value.

3. The power management system according to claim 2, wherein the set value is 105% of the system supply power level.

4. The power management system according to claim 2, wherein according to the charging rule, the charging management unit dynamically adjusts the charging capacities of the respective battery units if the system consumption power level is lower than the set value.

5. The power management system according to claim 4, wherein the set value is 105% of the system supply power level, wherein according to the charging rule, the charging management unit dynamically decreases the charging capacity of at least one of the respective battery units if the system consumption power level is 101%˜104% of the system supply power level.

6. The power management system according to claim 4, wherein according to the charging rule, the charging management unit dynamically increases the charging capacities of the respective battery units if the system consumption power level is lower than the system supply power level.

7. The power management system according to claim 4, wherein the charging rule contains a charging mode, wherein the charging management unit dynamically adjusts the charging capacity of each battery unit when the charging management unit is in the charging mode.

8. The power management system according to claim 7, wherein in the charging mode, a single battery unit of the plural battery units is charged at a time, wherein the charging management unit dynamically adjusts the charging capacity of each battery unit according to a charging sequence and a charging efficiency of each battery unit.

9. The power management system according to claim 7, wherein in the charging mode, a group of at least two battery units of the plural battery units is charged at a time, wherein the charging management unit dynamically adjusts the charging capacities of the battery units in each group according to a charging sequence of each group of the plural battery units and a percentage of total electric quantities of the battery units in each group with respect to total electric quantities of all of the plural battery units.

10. The power management system according to claim 7, wherein in the charging mode, the plural battery units are simultaneously charged, wherein the charging management unit dynamically adjusts the charging capacities of the battery units according to a percentage of the electric quantity of each battery unit with respect to total electric quantities of all of the plural battery units.

11. The power management system according to claim 1, wherein the charging management unit stops providing, dynamically decreases, maintains or dynamically increases the charging capacities of the respective battery units, so that the charging management unit dynamically adjusts the charging capacities of the respective battery units.

12. A power management method for a main system, a charging management unit and plural battery units, which are electrically connected with each other, the power management method at least comprising steps:
dynamically detecting electric quantities of the respective battery units and a system consumption power level of the main system;
the charging management unit calculating a system surplus supply power level according to a system supply power level and the system consumption power level; and
the charging management unit dynamically adjusting charging capacities of the respective battery units according to at least one of the electric quantities, the system surplus supply power level and a charging rule.

13. The power management method according to claim 12, wherein according to the charging rule, the charging management unit stops providing the charging capacities of the respective battery units if the system consumption power level is higher than the system supply power level and higher than a set value.

14. The power management method according to claim 13, wherein the set value is 105% of the system supply power level.

15. The power management method according to claim 13, wherein according to the charging rule, the charging management unit dynamically adjusts the charging capacities of the respective battery units if the system consumption power level is lower than the set value.

16. The power management method according to claim 15, wherein the set value is 105% of the system supply power level, wherein according to the charging rule, the charging management unit dynamically decreases the charging capacity of at least one of the respective battery units if the system consumption power level is 101%˜104% of the system supply power level.

17. The power management method according to claim 15, wherein according to the charging rule, the charging management unit dynamically increases the charging capacities of the respective battery units if the system consumption power level is lower than the system supply power level.

18. The power management method according to claim 15, wherein the charging rule contains a charging mode, wherein the charging management unit dynamically adjusts the charging capacity of at least one of the plural battery units when the charging management unit is in the charging mode.

19. The power management method according to claim 18, wherein in the charging mode, a single battery unit of the plural battery units is charged at a time, wherein the charging management unit dynamically adjusts the charging capacity of each battery unit according to a charging sequence and a charging efficiency of each battery unit.

20. The power management method according to claim 18, wherein in the charging mode, a group of at least two battery units of the plural battery units is charged at a time, wherein the charging management unit dynamically adjusts the charging capacities of the battery units in each group according to a charging sequence of each group of the plural battery units and a percentage of total electric quantities of the battery units in each group with respect to total electric quantities of all of the plural battery units

21. The power management method according to claim 18, wherein in the charging mode, the plural battery units are simultaneously charged, wherein the charging management unit dynamically adjusts the charging capacities of the battery units according to a percentage of the electric quantity of each battery unit with respect to total electric quantities of all of the plural battery units.

22. The power management method according to claim 12, wherein the charging management unit stops providing, dynamically decreases, maintains or dynamically increases the charging capacities of the respective battery units, so that the charging management unit dynamically adjusts the charging capacities of the respective battery units.
